(19) United States
(12) Patent Application Publication
(10) Pub. No.: US 2014/0355984 A1
(43) Pub. Date: Dec. 4, 2014

(54) COLORLESS, RECONFIGURABLE, OPTICAL ADD-DROP MULTIPLEXER (ROADM) APPARATUS AND METHOD

(71) Applicant: Calient Technologies, Inc., Goleta, CA (US)

(72) Inventor: Shifu Yuan, Camarillo, CA (US)

(21) Appl. No.: 13/904,930

(22) Filed: May 29, 2013

(51) Int. Cl. H04J 14/02

(52) U.S. Cl. CPC H04J 14/0212
USPC 398/48; 398/83

(57) ABSTRACT

A colorless, reconfigurable, optical add-drop multiplexer (a colorless ROADM) is disclosed. The ROADM may include a de-interleaver, a diffraction grating, and a lens. The de-interleaver may separate an input signal into a first output signal, comprising odd channels, and a second output signal, comprising even channels. The diffraction grating may receive the first and second output signals from the de-interleaver. The diffraction grating may separate each of the first and second output signals into individual channels. The lens may collimate the individual channels received from the diffraction grating.

### BACKGROUND

1. Field of the Invention

This invention relates to optical computer networks and more particularly to systems and methods for lowering the manual intervention required to reconfigure an add/drop node within an optical network.

2. Background of the Invention

Operators of computer networks, as well as those that supply network components to such operators, are seeking to lower the cost-per-bit to transfer data. One area of focus in this cost-reduction effort is driving as much functionality as possible out of the electrical layer and into the optical layer. As a result, reconfigurable optical add-drop multiplexers (ROADMs) have risen in prominence.

However, first generation ROADMs are constrained in certain areas such as reconfigurability and automation. These constraints are particularly noticable at add/drop nodes, where costly manual intervention is required. Accordingly, what is needed is an improved ROADM that lowers the required manual intervention.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram of one embodiment of an optical network for transferring data;

FIG. 2 is a schematic block diagram of one embodiment of a ROADM switching node;

FIG. 3 is a schematic block diagram of one embodiment of a switching subsystem that may be contained within a ROADM switching node;

FIG. 4 is a schematic diagram of one embodiment of selected components that may be contained within a ROADM including an optical distributor delivering a collimated, two-dimensional array of wavelength-specific light beams to an optical switch;

FIG. 5 is a schematic diagram of one embodiment of an interleaver performing an interleaving function;

FIG. 6 is a schematic diagram of one embodiment of an interleaver performing an de-interleaving function;

FIG. 7 is a schematic diagram providing a side view of an interleaver, lens, and diffraction grating of an optical distributor;

FIG. 8 is a schematic diagram providing a perspective view of an diffraction grating and collimator lens of an optical distributor;

FIG. 9 is a schematic diagram providing a top view of one embodiment of a channel (i.e., wavelength) distribution produced by a diffraction grating of an optical distributor;

FIG. 10 is a schematic diagram providing a front view of one embodiment of a first MEMS mirror array of an optical switch;

FIG. 11 is a schematic diagram providing a front view of one embodiment of a second MEMS mirror array of an optical switch;

FIG. 12 is a schematic diagram of an alternative embodiment of an optical distributor delivering a collimated, two-dimensional array of wavelength-specific light beams to an optical switch; and

FIG. 13 is a schematic diagram of a single-lens embodiment of an optical distributor.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

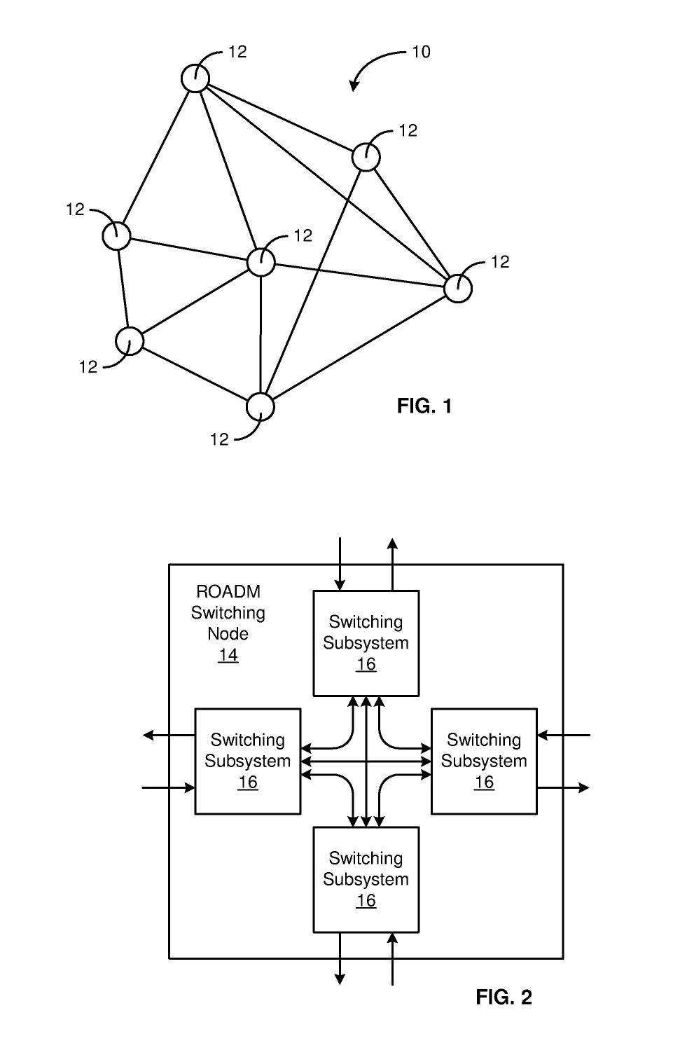

Referring to FIGS. 1 and 2, fiber-optic networks 10 are playing an increasingly important role in transmission of data. To provided the necessary capacity or bandwidth, fiber-optic networks 10 (e.g., nodes 12 within a fiber-optic network 10) commonly use wavelength-division multiplexing (WDM) to combine many independent optical signals of different wavelengths onto one optical fiber for long distance transmission. Accordingly, routing a signal through a network 10 may include demultiplexing, switching, recombining, and the like. To provide such functionality, one or more nodes 12 within a network 10 may include one or more ROADMs 14 (e.g., ROADM switching nodes 14).

A ROADM 14 may be defined as an optical subsystem (e.g., an all optical subsystem) that enables a remote network operator to control whether a particular wavelength is added, dropped, or passed through a node 12. A ROADM 14 may be characterized by the degrees of switching provided thereby. In selected embodiments, a ROADM 14 may have somewhere in the range of two to eight degrees of switching.

Each degree of switching may correspond to a different switching direction and may be associated with a transmission fiber pair. Accordingly, a two degree ROADM 14 may switch in two directions. These two directions may be referred to as East and West. Similarly, a four degree ROADM 14 may switch in four directions, which may be referred to as North, South, East, and West. In FIG. 2, a four degree ROADM 14 is illustrated. To support these four degrees of switching, the illustrated ROADM 14 includes at least four switching subsystems 16 (e.g., four wavelength selective switches).

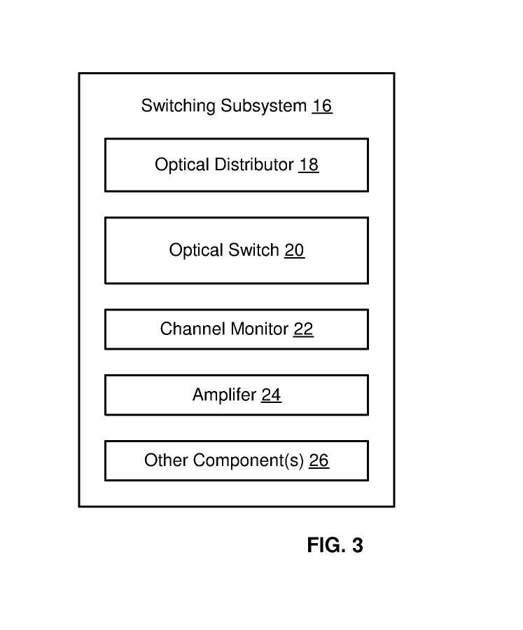

Referring to FIG. 3, in selected embodiments, a switching subsystem 16 may provide “colorless” functionality. That is, first generation ROADMs are typically limited by fixed wavelength assignments. Accordingly, in first generation ROADMs, when a wavelength is selected or rerouted, a transceiver must be manually connected to the correct mux/demux port at the add/drop site. However, in embodiments in accordance with the present invention, a switching subsystem 16 may automate the assignment of add/drop wavelength functionality. Accordingly, a switching subsystem 16 may enable any wavelength (i.e., color) to be assigned to any port of an add/drop site. Moreover, a switching subsystem 16 in accordance with the present invention may enable such an assignment to be made automatically (e.g., under the direction of a controlling software program), without the need for any manual work on site.

A ROADM 14 in accordance with the present invention may have any suitable configuration. For example, a ROADM 14 may include any suitable combination of electrical hardware, optical hardware, software, or some subset thereof. In selected embodiments, a ROADM 14 may include one or more switching subsystems 16. Each such switching subsystem 16 may include one or more of an optical distributor 18, optical switch 20, channel monitor 22, amplifier 24, some other component(s) 26, or the like.

An optical distributor 18 may prepare a signal for an optical switch 20. For example, in certain embodiments, an optical distributor 18 may generate a free space distribution of wavelengths. An optical switch 20 may enable one or more signals to be selectively switched from one circuit to another. A channel monitor 22 may assess the quality of channel data by measuring selected optical characteristics. Accordingly, a channel monitor 22 may ensure correct switching, set levels for dynamic equalization of the gain of an optical amplifier, provide system alarms and error warnings, or the like or some combination thereof. An amplifier 24 may amplify an optical signal. It may do so directly, without first converting the optical signal to an electrical signal.

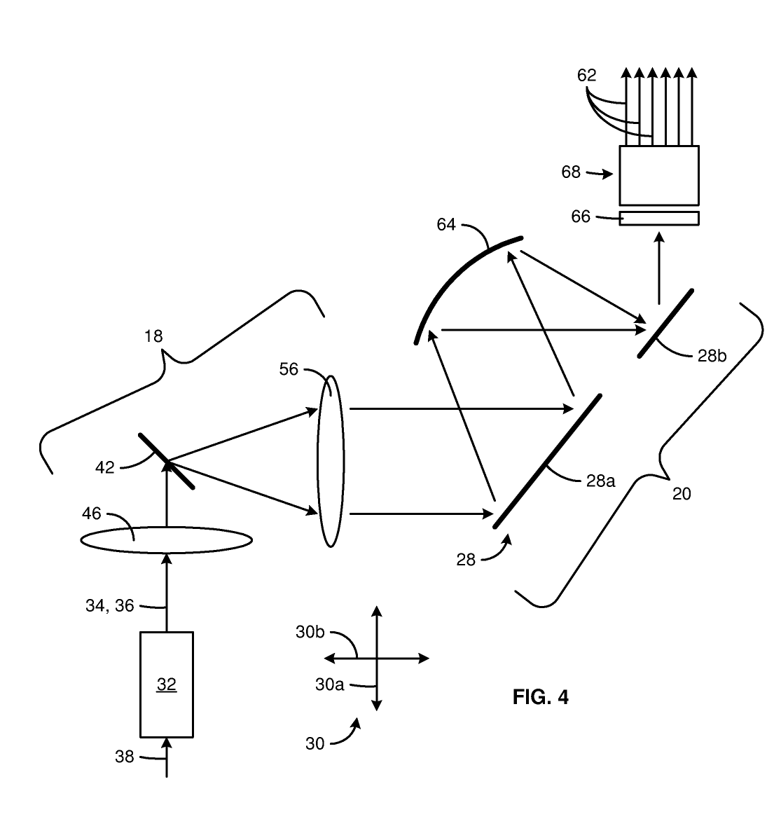

Referring to FIG. 4, in selected embodiments in accordance with the present invention, a switching subsystem 16 (e.g., a switch 20) may employ multiple microelectromechanical system (MEMS) mirror arrays 28 (e.g., arrays 28 of mirrors wherein each mirror pivots about two orthogonal axes). Accordingly, a switching subsystem 16 may be configured to overcome certain disadvantages and capture certain benefits that may be associated with MEMS mirror arrays 28.

For example, for a colorless ROADM 14 using three-dimensional MEMS mirror arrays 28, high deflection angles may make it difficult to properly switch forty channels, ninety-six channels, or the like arrayed in a single line. Also, there may be benefits to incorporating within a MEMs-based ROADM 14 a variable optical attenuation function. While the use of an arrayed waveguide grating (AWG) or a thin-film-based, dense wavelength division multiplexing (DWDM) device may reduce the need for optical attenuation, it may be beneficial to incorporate a wavelength demultiplexer, switch, and attenuation function inside a small module.

In selected embodiments, to overcome certain disadvantages and capture certain benefits that may be associated with MEMS mirror arrays 28, a switching subsystem 16 may couple an optical distributor 18 and an optical switch 20. In certain embodiments, an optical distributor 18 may generate a free space distribution of wavelengths that may be handled by a corresponding switch 20 with selective attenuation and without high deflection angles.

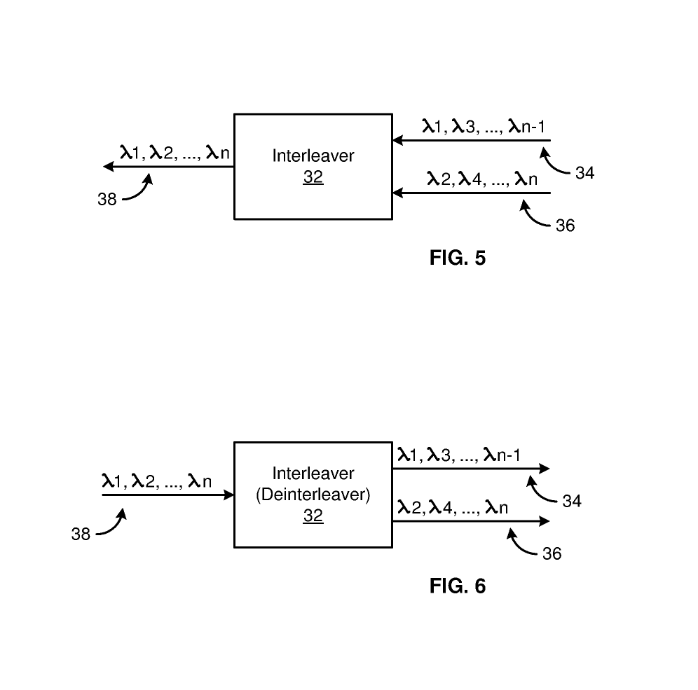

Referring to FIGS. 4-6, in discussing and illustrating a free space distribution of wavelengths, it may be helpful to establish a coordinate axes 30. For example, it may be helpful to discuss a free space distribution in terms of longitudinal 30a, lateral 30b, and transverse 30c directions extending orthogonally with respect to one another.

In selected embodiments, to provide a free space distribution of wavelengths, an optical distributor 18 may include an optical interleaver 32. In operation, an interleaver 32 may interleave multiple input signals to form a single output signal. For example, in selected embodiments or situations, an interleaver 32 may interleave a plurality of “odd” channels 34 with a plurality of “even” channels 36 to form a single composite signal 38. Alternatively, an interleaver 32 may deinterleave a single input signal to form multiple output signals. For example, in certain embodiments or situations, an interleaver 32 may deinterleave a single composite signal 38 into its constituent odd and even channels 34, 36.

An optical interleaver 32 in accordance with the present invention may comprise any suitable hardware or be configured in any suitable way. In selected embodiments, an optical interleaver 32 may operate in free space. This may provide a space-efficient and compact overall device and may eliminate the need for fusion splicing and two fiber collimators. However, a fiber-pigtail optical interleaver may still be suitable.

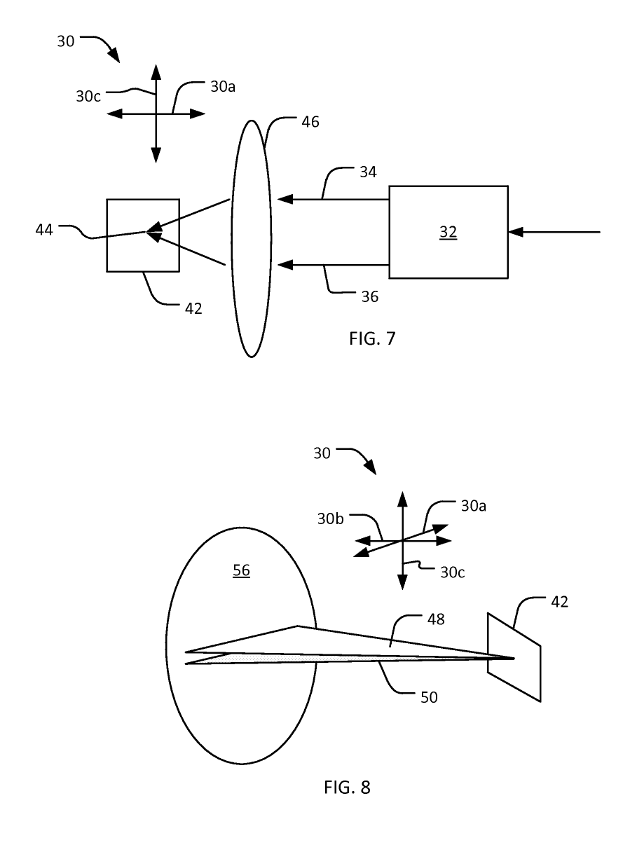

Referring to FIGS. 4 and 7, in certain embodiments, an optical distributor 18 may include an optical diffraction grating 42 (e.g., either a transmissive or reflective diffraction grating). In certain embodiments or situations, an optical diffraction grating 42 may receive the even and odd channels 34, 36 from an interleaver 32. For example, the even and odd channels 34, 36 may exit the interleaver 32 as parallel collimated beams. A lens 46 may focus the beams output from the interleaver 32 onto a common spot 44 on the diffraction grating 42.

Referring to FIGS. 4, 8, and 9, an optical diffraction grating 42 may receive from an interleaver 32 a plurality of light beams focused onto a common spot. The axes of the light beams may be separated by a small angles with respect to a first direction (e.g., a transverse direction 30c) from one another. An optical diffraction grating 42 may separate each such signal or beam in another direction (e.g., a longitudinal direction 30a). For example, a diffraction grating 42 may separate each light signal or beam into its constituent wavelengths or channels. Accordingly, acting in combination, an interleaver 32 and a diffraction grating 42 may generate a two-dimensional array of channels where each such channel occupies its own space.

In selected embodiments, an interleaver 32 may deliver two light signals or beams to a diffraction grating 42. A first light beam may comprise all of the even channels 34, while a second light beam comprises all of the odd channels 36. The diffraction grating 42 may distribute the even channels 34 within a first plane 48. The diffraction grating 42 may distribute the odd channels 36 within a second plane 50, space from the first plane 48. The angular spacing between the first and second planes 48, 50 may corresponding to or match the angular spacing at which the first and second beams are delivered to the diffraction grating 42.

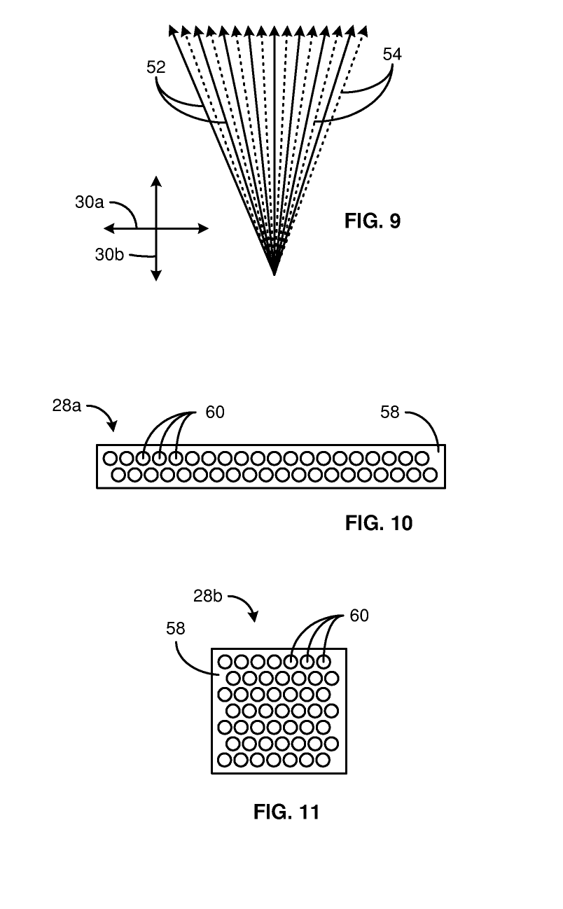

When viewed from a direction orthogonal to the first plane 48, second plane 50, or both, the paths of the various channels may be identified. For example, as shown in FIG. 9, the path 52 of each of the odd channels 36 may be illustrated using a solid line. The path 54 of each of the even channels 34 may be illustrated using a dashed line. Thus, as illustrated, in addition to a separation in one direction (e.g., a transverse direction 30c), the even and odd channels 34, 36 may also be spaced from one another in another direction (e.g., a longitudinal direction 30a).

In selected embodiments, an optical distributor 18 may include a second lens 56. Such a lens 56 may be positioned optically between a diffraction grating 42 and a switch 20. A second lens 56 may collimate the various channels output by a diffraction grating 42. Accordingly, an optical distributor 18 may deliver to a switch 20 a collimated, two-dimensional array of wavelength-specific light beams that may be properly handled by the switch 20.

Referring to FIGS. 4, 10, and 11, a switch 20 in accordance with the present invention may have any suitable configuration. In selected embodiments, a switch may be MEMS-based and include multiple MEMS mirror arrays 28. For example, in certain embodiments, a switch 20 may include a first MEMS mirror array 28a and a second MEMS mirror array 28b.

The first and second mirror arrays 28a, 28b may each include a substrate 58 supporting a plurality of mirrors 60. Each of the mirrors 60 may be pivotally secured to the corresponding substrate 58 to enable two-dimensional pivoting. In selected embodiments, electrostatic actuators may be located in the respective substrates 58. A voltage may be applied to each of the electrostatic actuators to produce a desired pivoting of a corresponding mirror 60.

A first array 28a may receive a collimated, two-dimensional array of wavelength-specific light beams from an optical distributor 18. A first array 28a may selectively reflect those channels on to other components within the switch 20. For example, by pivoting a particular mirror 60 of a first array 28a, a corresponding channel may be reflected onto a particular mirror of a second array 28b. Pivoting of the particular mirror 60 of the second array 28b may result in the channel being reflected into a particular fiber 62.

Accordingly, one pivoting mirror 60 of a first array 28a may be located in the path of each channel being propagated by an optical distributor 18. The pivoting mirrors 60 may each pivot relative to a mirror substrate 58 to alter an angle at which the channel is reflected therefrom. The angle may be controlled so that the channel eventually falls on a desired pivoting mirror 60 of a second array 28b in line with a respective fiber 62 to which the channel is to be switched.

In selected embodiments, a mirror 64 may be positioned optically between a first array 28a and a second array 28b. Accordingly, a mirror 64 may direct the channels from a first array 28a to a second array 28b. Such a mirror 64 may have any suitable configuration. For example in certain embodiments, a mirror 64 may comprise a single, substantially flat surface. Alternatively, a mirror 64 may be curved to assist in reducing the deflection angles imposed on the mirrors 60 of the first and second arrays 28a, 28b.

A second array 28b may receive various channels from a mirror 64 and selectively reflect the channels into a lens array 66. A lens array 66 may include a plurality of focusing lenses. A lens array 66 may be mounted to a fiber block 68 such that each focusing lens is located optically over the end of a corresponding output optical fiber 62. For example, a particular mirror 60 of a second array 28b may reflect a channel onto a particular lens located within the lens array 66. The particular lens may then pass (e.g., focus) the channel into the particular fiber 62.

The positions and orientations of the various components of an optical distributor 18 and an optical switch 20 may be arranged in any suitable manner. For example, in certain embodiments, a first array 28a may be positioned so as to be coplanar with a second array 28b. Alternatively, first and second arrays 28a, 28b may be positioned so as to be non-coplanar.

Similarly, the respective positions and orientations between an optical distributor 18 and an optical switch 20 may be arranged in any suitable configuration. For example, as illustrated in FIG. 4, the components 28a, 28b, 32, 42, 46, 56, 64, 66, 68 of an optical distributor and switch 18, 20 may be substantially coplanar (e.g., bisected by a plane containing the longitudinal and lateral directions 30a, 30b). Alternatively, the components 28a, 28b, 32, 42, 46, 56, 64, 66, 68 of an optical distributor and switch 18, 20 may be substantially non-coplanar. For example, the components 32, 42, 46, 56 of an optical distributor 18 may be largely bisected by one plane (e.g., a plane containing the longitudinal and lateral directions), while the components 28a, 28b, 64, 66, 68 of an optical switch 20 may be largely bisected by a different plane (e.g., a plane containing the lateral and transverse directions 11b, 11c).

In selected embodiments, a first array 28a may be configured to receive the channels delivered thereto by an optical distributor 18. For example, in certain embodiments, an optical distributor 18 may output a two-dimensional array of wavelength-specific light beams arranged in two rows of twenty channels. Accordingly, a first array 28b may comprise a two-dimensional array of mirrors 60 arranges in two rows of twenty, as shown in FIG. 10.

In certain embodiments, a first array 28a may be arranged in an interleaved manner and configured to provide 100% yield. For example, the rows of channels output by an optical distributor 18 may be slightly offset from one another. Accordingly, the rows of mirrors 60 on a first array 28a may be similarly offset from one another.

First and second arrays 28a, 28b need not present identical, multi-dimensional arrays of mirrors 60. While a first array 28a may be configured to match an output of an optical distributor 18, a second array 28b may have mirrors 60 arranged for some other purpose. In selected embodiments, a second array 28b may have more mirrors 60 than a first array 28a. That is, the second array 28b need not have 100% yield. Alternatively, or in addition thereto, the mirrors 60 of a second array 28b may be interleaved, arranged to lower the required angles of deflection, arranged to be less sensitive to vibration, and or the like or some combination thereof.

By employing an optical distributor 18 in accordance with the present invention, a switching subsystem 16 may support the use of larger MEMS mirrors 60 with larger pitch. Moreover, such an arrangement may enable the use of small deflection angles for all mirrors 60. For example, when using a curved intermediate mirror 64, deflection angles for all mirrors 60 of the first and second arrays 28a, 28b may be less than five degrees. This may reduce the sensitivity of a switch 20 to vibration. Additionally, a first array 28a may have a larger deflection angle in one axis and a smaller deflection angle in another axis. The smaller deflection angle may be used for attenuation and switching only two or four rows. The larger deflection angle may be used for switching in larger space.

A combination between an optical distributor 18 and a corresponding optical switch 20 may be configured to operate (i.e., pass signal) in a first direction, operate in a second direction opposite to the first direction, or selectively switch between operation in the first direction and operation in the second direction. When operating in the first direction, a combined distributor 18 and switch 20 may receive signal on a single fiber 38 and output signal on several fibers 62 (e.g., forty fibers 62). When operating in the second direction, a combined distributor 18 and switch 20 may receive signal on multiple fibers 62 (e.g., forty fibers 62) and output signal on a single fiber 38. Accordingly, the functionality of the various components 28a, 28b, 32, 42, 46, 56, 64, 66, 68 may be reversed.

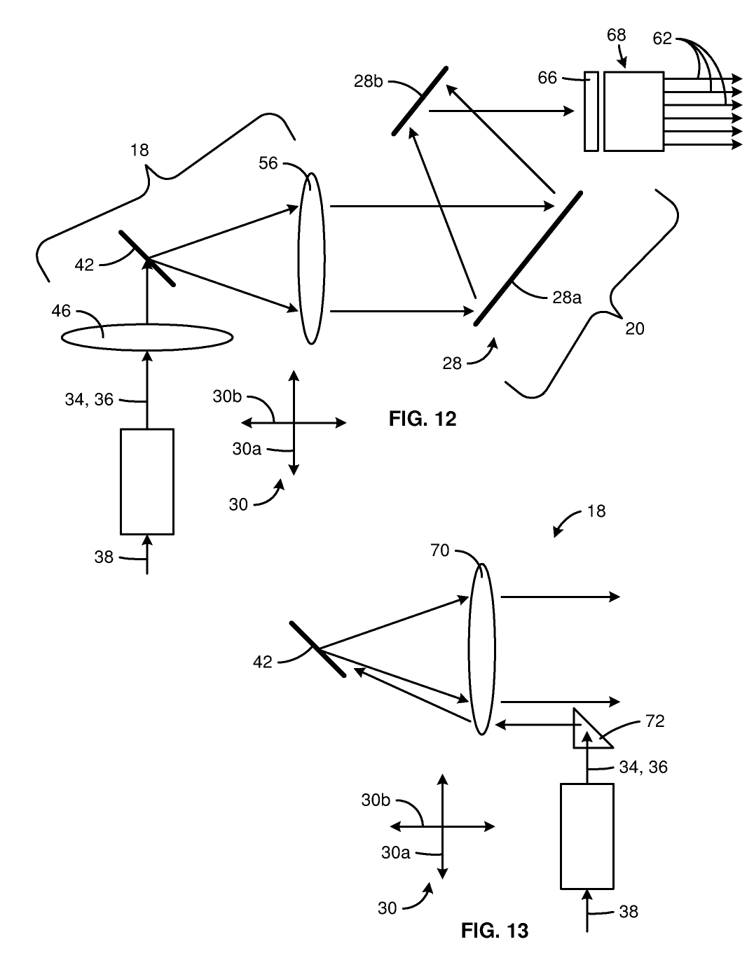

Referring to FIG. 12, in selected embodiments, an optical switch 20 may operate without a mirror 64 positioned optically between the first and second arrays 28a, 28b. Accordingly, when signal is traveling in the first direction, a first array 28a may reflect channels directly to a second array 28b. Conversely, when signal is traveling in the second direction, a second array 28b may reflect channels directly to the first array 28a.

Referring to FIG. 13, in certain embodiments, an optical distributor 18 may include a single lens 70. This single lens 70 may perform the functions of both lens 46, 56 included in other embodiments. For example, when signal is traveling in the first direction, a single lens 70 may both direct the even and odd channels 34, 36 onto the diffraction grating 42 and collimate the channels output by the diffraction grating 42.

When geometric or space considerations dictate, certain embodiments of an optical distributor 18 may include a reflector 72. For example, in selected embodiments involving a single lens 70, an optical distributor 18 may include a reflector 72 positioned optically between an interleaver 32 and the lens 70. This may enable an interleaver 32 to be positioned at an out of the way location.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A reconfigurable optical add-drop multiplexer (ROADM) comprising:
a de-interleaver;
a diffraction grating;
a lens;
the de-interleaver separating an input signal into a first output signal, comprising odd channels, and a second output signal, comprising even channels;
the diffraction grating receiving the first and second output signals from the de-interleaver;
the diffraction grating separating each of the first and second output signals into individual channels;
the lens receiving the individual channels from the diffraction grating; and
the lens collimating the individual channels.

2. The ROADM of claim 1, further comprising an optical switch.

3. The ROADM of claim 2, wherein the optical switch receives the individual channels from the lens.

4. The ROADM of claim 3, further comprising a fiber array.

5. The ROADM of claim 4, wherein the optical switch conducts the individual channels into the fiber array.

6. The ROADM of claim 5, wherein the optical switch comprises a first MEMS mirror array and a second MEMS mirror array.

7. The ROADM of claim 6, wherein each mirror of the first MEMS mirror array pivots about two axes extending substantially orthogonally with respect to one another.

8. The ROADM of claim 7, wherein the optical switch further comprises a reflector.

9. The ROADM of claim 8, wherein the reflector receives the individual channels from the first MEMS mirror array and reflects the individual channels to the second MEMS mirror array.

10. The ROADM of claim 9, wherein the reflector comprises a reflective surface that is curved.

11. A reconfigurable optical add-drop multiplexer (ROADM) comprising:
an interleaver;
a diffraction grating;
a lens directing a plurality of individual channels onto the diffraction grating;
the diffraction grating combing the plurality of individual channels to form a first beam comprising a plurality of odd channels and a second beam comprising a plurality of even channels;
the interleaver receiving from the diffraction grating the first and second beams;
the interleaver interleaving the odd and even channels to produce a third signal; and
the interleaver outputting the third signal.

12. The ROADM of claim 11, further comprising an optical switch.

13. The ROADM of claim 12, wherein the optical switch delivers the plurality of individual channels to the lens.

14. The ROADM of claim 13, further comprising a fiber array.

15. The ROADM of claim 14, wherein the optical switch receives the plurality of individual channels from the fiber array.

16. The ROADM of claim 15, wherein the optical switch comprises a first MEMS mirror array and a second MEMS mirror array.

17. The ROADM of claim 16, wherein each mirror of the first MEMS mirror array pivots about two axes extending substantially orthogonally with respect to one another.

18. The ROADM of claim 17, wherein the optical switch further comprises a reflector.

19. The ROADM of claim 18, wherein the reflector receives the individual channels from the first MEMS mirror array and reflects the individual channels to the second MEMS mirror array.

20. The ROADM of claim 19, wherein the reflector comprises a reflective surface that is curved.

21. A method of optical add-drop multiplexing comprising:
de-interleavering an input signal into a first output signal, comprising odd channels, and a second output signal, comprising even channels;
separating the first output signal into a first array of constituent channels;
separating the second output signal into a second array of constituent channels;
identifying a destination fiber for each channel of the first and second arrays; and
directing each channel of the first and second arrays into the destination fiber identified therefore.

22. The method of claim 21, wherein the directing comprises reflecting each channel off at least one MEMS mirror.

23. A method of optical add-drop multiplexing comprising:
directing onto a diffraction grating a plurality of individual channels consolidating, by the diffraction grating, the plurality of individual channels into a first beam, comprising even channels of the plurality of individual channels, and a second beam, comprising odd channels of the plurality of individual channels;
receiving, by an interleaver, the first and second beams; and
interleaving, by the interleaver, the first and second beams to form a third beam.

24. The method of claim 23, wherein the directing comprises reflecting each channel of the plurality of individual channels off at least one MEMS mirror.
